(19) United States
(12) Patent Application Publication
(10) Pub. No.: US 2009/0055270 A1
(43) Pub. Date: Feb. 26, 2009

(54) Method and System for Delivering Targeted Advertising To Online Users During The Download of Electronic Objects.

(76) Inventors: Malik Magdon-Ismail, Loudonville, NY (US); Parag Patel, Marina del Rey, CA (US)

Correspondence Address: PARAG PATEL, 4708 LA VILLA MANNA, UNIT G, MARINA DEL RAY, CA, 90292, US

(21) Appl. No.: 12/196,168

(22) Filed: Aug. 21, 2008

Related U.S. Application Data
(60) Provisional application No. 60/956,923, filed on Aug. 21, 2007.

(51) Int. Cl. G06Q 30/00; G06F 17/30

(52) U.S. Cl. 705/14; 707/100; 707/E17.044

(57) ABSTRACT

A good time to present an online advertisement to an online User is when he or she is not distracted and can or would like to pay attention to an advertisement. An instance of such time, the “period of inactivity”, may occur, for example, after a User initiates a download of content and before that User begins to view the content being downloaded. The present method and system provides online advertisements to Users during periods of inactivity as well as incentivising website owners with downloadable content to participate in presenting such advertisements to their audiences.

### CROSS-REFERENCE TO RELATED APPLICATIONS

This application is a continuation in part of U.S. patent application Ser. No. 11/552,268 (filed on Oct. 24, 2006), U.S. patent application Ser. No. 11/677,172 (filed on Feb. 21, 2007) and U.S. Provisional Patent Application 60/912, 907 (filed Apr. 19, 2007). The entire disclosures of these priority applications are hereby incorporated by reference herein.

### BACKGROUND OF THE INVENTION

### Field of the Invention

The present invention generally relates to online advertising methods and systems.

### Background of the Invention

Worldwide use of the Internet is growing at an extremely rapid pace. Millions of people worldwide use the Internet daily for accessing information, shopping, recreation, receiving product updates and other communications. As computers and Internet access become less expensive and easier to use, use of the Internet will become even more widespread. As a result, many start-up and established companies and others (“Advertisers”) increasingly view the Internet as a profitable place to advertise their goods and services.

Generally a good time to present an advertisement is when an online User is not distracted and can or would like to pay attention to an advertisement. An instance of such time, the “period of inactivity”, may occur after a User initiates a download of content and before that User begins to view the content being downloaded. For example, a period of inactivity may occur while a User is waiting for an online download to complete or while a User Device is buffering or re-buffering content (e.g. streaming audio, video and the like) before exhibiting such content to the User. Other examples of periods of inactivity include while a User is waiting: (i) for a complex webpage to load, (ii) for content to be uploaded, (iii) for another User to complete typing and sending an instant message (or other real time communication), (iv) for files to transfer internally (within a PC including external drives), externally (within a local network) or via the internet or other global network, (v) for CDs, DVDs and similar media to be burnt, (vi) for a computer or terminal to boot up, (vii) for software to install, (viii) for large files to open, (ix) for applications (e.g. Microsoft Word) to open, (x) for a scan to complete, (xi) for pictures or video to be imported from a digital camera or camcorder and (xii) for a connection to a network (e.g. while acquiring an IP address on a wireless or wired network). The above is not intended as a limitation on what constitutes a “period of inactivity”. Those in the field may readily ascertain several other instances of a similar nature.

Internet Users upload and download a variety of objects such as text (e.g. pdf or word documents), real-time communications (e.g. instant messaging), music (e.g. MP3 files), video (e.g. mpeg files), streaming content (e.g. videos, music), webpages (e.g. HTML files) to software (collectively referred to hereinafter as “downloads”). These downloads may be accessed from websites, web-links, attachments to e-mails (e.g. using a webmail interface). The duration of downloads may be anywhere from a few seconds to several hours. Typically if a download takes a relatively short amount of time (for example 5-30 seconds, although such time-period is meant only as an example, and not to limit the scope of this invention), many Users may wait for the download to occur (i.e. the period of inactivity) instead of opening other browser windows, engaging in other computing functions or leaving their computers for offline activities. The present method and system delivers advertising, both targeted and non-targeted, to online Users during this period of inactivity. The method and system further presents incentive mechanisms for website owners and others with downloadable content to require or encourage their audience to accept delivery of such advertising.

### BRIEF DESCRIPTION OF THE DRAWINGS

FIG. 1 is a block diagram overview of a system according to some embodiments.

FIG. 2 is a flow chart of a method according to some embodiments.

FIG. 3 is a flow chart of a method according to some embodiments.

FIG. 4 is a display of a Download Progress Toolbar according to some embodiments.

FIG. 5 is a flow chart of a method according to some embodiments.

FIG. 6 is a flow chart of a method according to some embodiments.

### DETAILED DESCRIPTION OF THE INVENTION AND PREFERRED EMBODIMENTS

The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. Note that any of the methods described herein may be performed by hardware, software (including microcode), firmware, or any combination thereof. For example, a storage medium may store thereon instructions that when executed by a machine result in performance according to any of the embodiments described herein. Thus, the present invention is not intended to be limited to the embodiments shown and the inventor regards his invention as any patentable subject matter described.

The following presents a method and system for presenting advertising to a User while that User is downloading a variety of objects from an online network, such as the Internet.

The above-referenced patent applications (paragraph [0001]) describe various systems and methods to determine how to target online advertisements to Internet Users using behavioral, demographic, search, navigational and other advertisement targeting methods. In the present method and system, targeting may, in addition to those methods, include use of data relating to the specific object being downloaded, in particular, the type of content, nature of the website, communications, keywords from within an e-mail or instant message, services provided by the download, software program and other commonly known properties of such object. The targeted advertisement may be presented to the User during the same download or during future downloads. Alternatively, the present invention may include only use of data relating to the object being downloaded or of only of certain User-approved data. As a further alternative, the present invention may not use any kind of user data, and present random advertisements (i.e. non-targeted advertising) to the User during downloads.

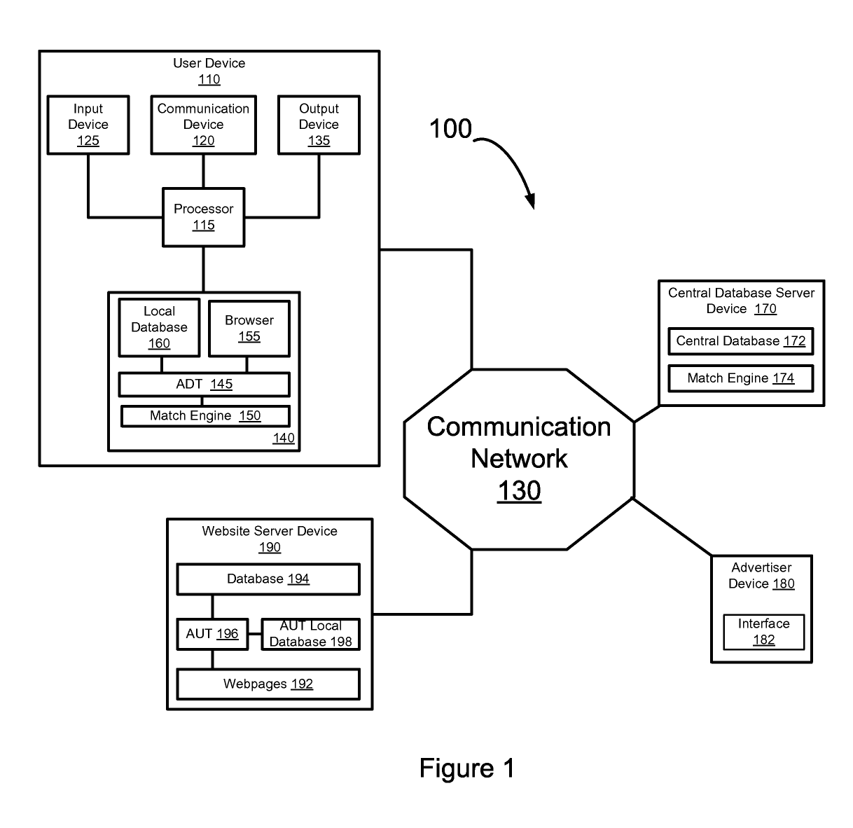

Turning now in detail to the drawings, in FIG. 1 a block diagram of a system 100 is depicted for use in explanation, but not limitation, of described embodiments. Upon reading this disclosure, those skilled in the art will appreciate that different types, layouts, quantities, and configurations of systems may be used.

The User Device 110 may include a Processor 115, such as one or more INTEL™ processors, coupled to a Communication Device 120 (e.g. a cable or Digital Subscriber Line (DSL) modem) configured to communicate via a Communication Network 130, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Note that the devices shown in FIG. 1 need not be in constant communication. For example, the User Device 110 may only communicate with the Website Server Device 190 or the Central Database Server Device 170 via the Internet on an as-needed basis. In some embodiments, for example, the User Device 110 may be a Personal Computer (PC) that intermittently utilizes a dial-up connection to the Internet via an Internet Service Provider (ISP). In other embodiments, the User Device 110 may be in constant and/or high-speed communication with the Website Server Device 190 and the Central Database Server Device 170. The Communication Network 130 may be or include multiple networks of varying type, configuration, size and/or functionality. The User Device 110 may further include an Input Device 125 (e.g., a mouse and/or keyboard) and an Output Device 135 (e.g., a computer monitor).

The Processor 115 may communicate with a local storage device 140. The local storage device 140 may comprise of any appropriate information storage device known or available, including, but not limited to, combinations of magnetic storage devices (e.g., a hard disk drive), optical storage devices, and/or semiconductor memory devices such as Random Access Memory (RAM) devices and Read Only Memory (ROM) devices. The storage device 140 may, for example, store the ADT program 145 and its Match Engine 150 which may collectively or separately control the Processor 115. The Processor 115 may perform instructions of the ADT program 145 and/or the Match Engine 150 to operate in accordance with embodiments described herein. For example, the Processor 115 may arrange for a ADT visual interface to be displayed to a User on Output Device 135 as configured by the Browser software program 155 (e.g. Microsoft's Internet Explorer) or as a standalone interface (as configured by a part of the ADT program 145). The local storage device 140 also may have a Local Database 160 which may store or cache information, such as User download activity, preferences, profiles, navigational history, online advertisements and the like.

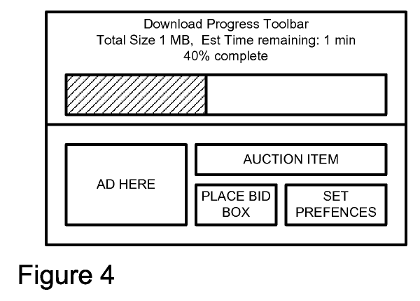

Targeted advertisements are displayed on the Output Device 135 to the User on a Browser 155, a download bar (e.g. FIG. 4) or other visual interface while the User is downloading an object from a Website Server Device 190. The Website Server Device 190 (also run by a processor which is not shown) contain Webpage files 192 which a User Device 110 may selectively access using the Communication Network 130. Upon User selection, the Webpages files 192 may access a Website Server Database 194 to retrieve additional files to render a webpage on the User Device's Output Device 135. The Webpage files 192 may also access the Website Server Database 194 to obtain files that the User seeks to download. In some embodiments, when a Website Server Device 190 owner has downloaded the AUT program, the AUT program 196 instructs the Website Server Device 190 processor (not shown) to monitor when Webpage files 192 access the Database 194 for User-initiated downloads. The AUT program 196 may also use a separate AUT Local Database 198 which store preferences of the Website Server Device 190 owner, thereby altering the scope of AUT program 196 instructions for the Website Server Device 190 processor. In some embodiments, the AUT program 196 may store additional group data, such as the most popular recent User-initiated downloads and other relevant usage or traffic information in the AUT Local Database 198. Such data may be additionally analyzed by the system 100 to display better targeted advertisements to the User.

When a User Device 110 accesses a Webpage file 192 using the Communication Network 130 and initiates a download from the Database 194, the AUT program 196 accesses the website owner settings in the AUT Local Database 198 and then, depending on such settings, gathers and analyzes information about the type of object being downloaded. Depending on website owner settings, the information may then be transmitted via the Communication Network 130 to the Central Database Server Device 170 for intelligent matching or, to speed up processing, intelligent matching may be performed within the AUT Local Database 198. In the latter case, relevant data may be transmitted or synchronized between the AUT Local Database 198 and the Central Database 172 during periods of low bandwidth use. Intelligent matching of the User with an advertisement (and/or bidding opportunity) is performed on a Central Database Server Device 170, which contains a Central Database 172 (which contains user and/or group information data and advertisement/bidding opportunities) and a Matching Engine 174. Regarding User data collection on the User Device 110, the ADT program 145 may collect some or all of the following examples of data based on the User's personal preferences: navigation information, search engine requests, personal/demographic information and download activity. The ADT program 145 stores such information in the Local Database 160. In some embodiments, and depending on the User's privacy preferences, the ADT program 145 may synchronize or transmit relevant data between the Local Database 160 and/or Local Match Engine 150 and the Central Database Server's 170 Central Database 172 and Match Engine 174. This enables collection and analysis of more useful data which may lead to better targeted advertisements. It also enables transmission of information between the User Device 110 and Central Database Server 170 during periods of light or no bandwidth use.

Accordingly, an advertisement may be selected, transmitted to the User Device 110 during a non-download or other low bandwidth usage period (thereby maximizing bandwidth for User's intended activities), stored in the Local Database 160 and presented to the User during a future period of inactivity. Thus, a User may retain his or her full bandwidth for downloading a desired object and still receive a relevant advertisement or bidding opportunity during a period of inactivity. Such method facilitates presenting an advertisement even during a fast download without affecting the User's bandwidth significantly or at all. The Local Database 160 is additionally envisioned to encapsulate all information relating to the User, thereby becoming the online personality of the User and enabling this system and method to provide relevant, personalized advertisements to the User. In some embodiments, such information may reside solely on the User Device 110, and the User may be permitted to access and add, edit or delete such information.

To receive online advertisement information in its Central Database 172, the Central Database Server 170 may be connected to an Advertiser Device 180 through the Communication Network 130 or a private direct connection. Using an interface 182 (e.g. an advertiser-specific account webpage) on the Advertiser Device 180, advertisers may send their online advertisements (or merchants may send bidding opportunities) through the Communication Network 130 to the Central Database Server Device's 170 Central Database 172 and Match Engine 174. Advertiser Devices 180 may be used, for example, by individual advertisers, advertising agencies or advertising networks (e.g. DoubleClick, Advertising.com, etc.). Alternatively or additionally, advertising networks may directly access (not shown) the Central Database Server Device to obtain download activity, demographic, navigational, search engine request and other types of user information before applying the Central Database Match Engine 174 (or their own match engines) to determine an appropriate advertisement to be transmitted to the User Device 110. If a User elects not to share his or her Local Database 160 information (or to limit the scope of such information), a similar matching process may take place within the User Device 110; for example, the ADT program may access the Local Database 160 to access relevant user data. The data is analyzed by the Local Match Engine 150, which then transmits non-User information (e.g. categories of advertisements) to the Central Database Server Device 170, which in turn may send an appropriate advertisement for presentation during the current or future User download. To the extent that a User elects to share his or her information, the Central Database Server Device 170 may perform additional matching using user, group and other relevant data to select and transmit a targeted advertisement to the User Device 110.

The ADT 145 and AUT 196 programs and the Match Engines 150 and 174 may be stored in a compressed, uncompiled and/or encrypted format. They may furthermore include other program elements, such as an operating system, a database management system, and/or device drivers used by processors to interface with peripheral devices.

As used herein, information may be “received” by or “transmitted” to, for example: (i) the User Device 110 from another device; or (ii) a software application or module within the User Device 110 from another software application, module, or any other source. Although the components 115 to 160 (except for Communication Network 130) are described with respect to a User Device 110, those skilled in the art will appreciate that the other devices described herein may include these and/or similar components or functionalities. The User Device 110 (and other devices) may also include fewer or more components than those shown in FIG. 1.

In a preferred embodiment, the ADT software 145 and Local Database 160 are customized to a particular User profile and may provide better matched opportunities as they collect more information about that User. Additional Users sharing the same User Device may have separate Local Databases. Selection of which Local Database to access may be manual (i.e. a User may actively select his or her User profile) or automatic (the ADT program may use techniques, such as artificial intelligence, to switch between User profiles based, for example, on the current User's navigation, login information and time of use).

The software may implement methods of artificial intelligence to perform the above customized analysis as described below. The ADT software program, 415, when interfaced with a Browser 155 collects inputs which include:

User preferences;

Long term and short term historical browsing profile of the user;
Based on pages browsed and overall categorical information of webpages, including categorical information in the bidding engine data base, the long term and short term browsing profile of the user are categorized into one or more categories.

Categories have associated attributes, such as, but not limited to:
Current-fashionability-value (CFV): for example, summer clothing toward the end of spring has a high CFV; CFV can be automatically determined by Artificial Intelligence (AI) systems based on an average over many users' recent purchases versus historical purchases.
Specificity (SPF): for example, is the user browsing a general category such as electronics (lower SPF) versus is the user browsing for an IPOD musical device (higher SPF).
Deviations of Short Term from Long Term (StLtDev): how different is the user's short term historical browsing compared to long term historical browsing. Such a parameter could for example be used to indicate a recent urge of the user versus a long term interest.

Based on the parameters collected (including but not limited to those as described above) and based on the Local Database, 160, the ADT software 145 automatically determines how often to synchronize or exchange relevant data with the Central Database Server 170 and how often to present the User with advertisements and bid opportunities as well as what advertisements or bid opportunities to present to such User.

Although a single User Device 110, a single Website Server Device 190, a single Central Database Server Device 170 and a single Advertiser Device 180 are illustrated in FIG. 1, any number of these devices may be included in the system 100. Similarly, any number of the other devices described herein may be included in the system 100 according to some embodiments.

The User Device 110 and the Website Server Device 190 may be any known or available devices capable of performing the various functions described herein. The User Device 110 may be, for example: a PC, a portable computing device such as a Personal Digital Assistant (PDA), an interactive television device, a mobile phone or any other appropriate storage and/or communication device. Either or both of the Website Server Device 190 and the Central Database Server Device 170 may be, for example, content servers such as web servers.

### Downloading and Configuring ADT.

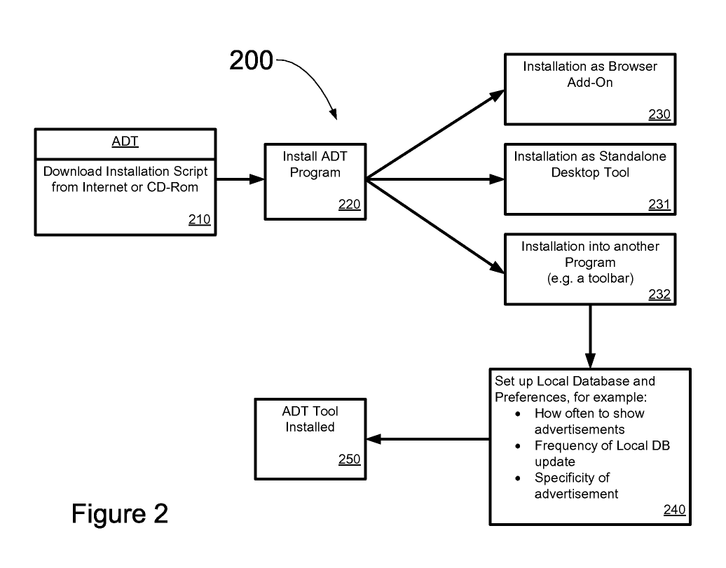

FIG. 2 shows a flowchart illustrating how a User may download and install a software program configured to run as an computer utility tool (referred to herein as an “Auto Download Tool” or “ADT”) which performs the tasks stated herein. At step 210, the software may be delivered to User by download or physical medium (e.g. a CD). At step 220, the User is prompted to install an appropriate version of ADT. The User may then elect to install the software program in an appropriate manner, for example, as an “add-on” to popular internet browsers such as Microsoft's Internet Explorer or Mozilla Firefox (step 230), as a standalone utility tool (step 231) or as an integrated part of another software product (e.g. the “bidding toolbar” described in U.S. Provisional Patent Application 60/912,907) (step 232).

Whether as a standalone tool (with its own graphical user interface) or in combination with a bidding toolbar or a popular browser, ADT may be configured to set up a local database, to collect browsing history and other contextual, behavioral, search, navigational and other data and to process all downloads (step 240). In some embodiments (as shown in step 240), Users may set preferences and parameters (using the standalone GUI or a preferences table that appears using a browser pull-down menu) to indicate preferences, such as whether and/or to what extent data collection is permitted, when advertisements are permitted, the nature of permitted advertisements, their frequency, their degree of relevancy to the User and the like. Users may also provide demographic, geographic and other information about themselves so they may receive better targeted advertisements or direct bidding opportunities (for example when using in combination with the bidding toolbar). At this stage, ADT installation is complete (step 250), although it may continue to receive updates to further enhance its use (e.g. updated features, functionality, effectiveness and User experience).

If multiple Users share a single computer, some or all such Users may state their preferences and input their individual data into separate profiles in ADT. When browsing, a User may select his or her profile (e.g. by using a pulldown menu selection tool on a toolbar) or ADT may be configured to apply techniques, such as artificial intelligence, to recognize which User is currently browsing (e.g. based on websites visited, login information inputted, time (e.g. morning, evening) of surfing, etc.) and automatically adjust to the current User's settings or to guest settings if the User is not recognized. The above User-identification technique may also be used in a variety of other User tracking applications (e.g. the bidding toolbar, Alexa toolbar), and the disclosure herein of such method and system is not intended to be limited in scope as to apply solely to ADT.

### Using ADT to Download Content.

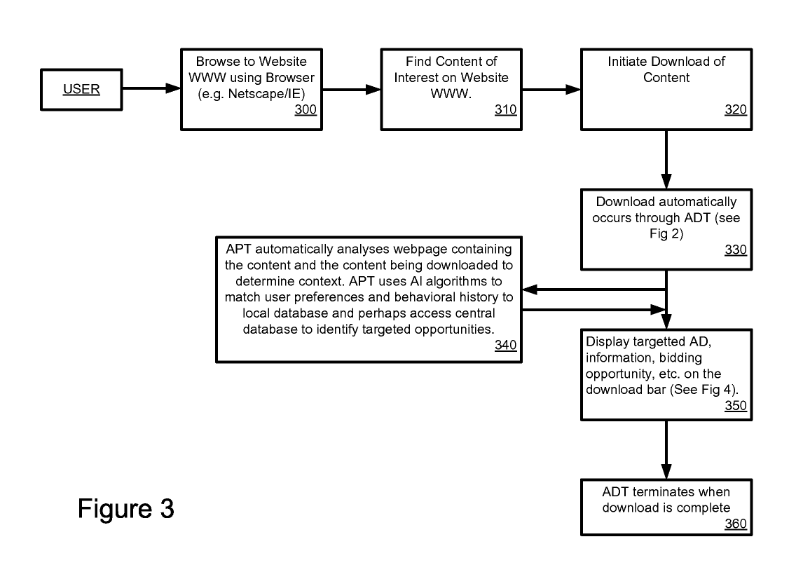

FIG. 3 shows a flowchart illustrating a typical User-ADT interaction. The User browses to a website (step 300) and discovers downloadable content that is of interest to the User (step 310). Upon User-initiated download of content (step 320), ADT (regardless of whether it is a standalone, add-on to a browser or integrated with another utility) begins to process the download (step 330). Depending on the User's preferences, ADT may do some or all of the following: access and collect data about the nature, type and other qualities of the content being downloaded and analyze such data by itself or in combination with other data from behavioral, demographic, search and other sources. Such data may be pulled from the User's local database and/or from a central database (which may, for example, contain relevant group data) that may be connected to the User's computer via a network (e.g. the Internet). Also based on the User's preferences, ADT may transmit some or all of the data and analysis to the central database. The central database may contain or be linked to matching engines that analyze the data and transmit a targeted advertisement or bidding opportunity (step 340) back to the User's computer for presentation to the User. If a User prefers not to send any data to the central database, a local engine may analyze the data in the User's local database and then request the central servers to select a targeted advertisement. Both local and central engines may incorporate analysis techniques, such as artificial intelligence, machine learning and other techniques, which are well known in the art to perform the above functions.

Once a relevant advertisement is selected, it is sent back to the User's computer and displayed to the User during the download or for a longer time-frame if a User selects it, browses over it or manifests some other intention to continue viewing it. The advertisement may be displayed within the download bar graphical interface (see FIG. 4), adjacent to it, as a pop-up, slide-down, transparent or in any manner well known in the art (step 350). The User may additionally be given options to bid on a product or service (e.g. if ADT is incorporated into the bidding toolbar), identify whether the advertisement was useful and/or opt out of future advertisements. Such data may be analyzed to determine whether said advertisements are appropriate for display based on, for example, length of download and user preferences.

Alternatively, if the User specifies preferences that limit or completely disallow any collection and/or transfer of information to a central database, then step 340 may be bypassed and the User may view a non- or partially-targeted advertisement (step 350) or no advertisement at all.

Method and System to Incentivize Website Owners to Require or Recommend ADT to their Users

A method and system for providing incentive mechanisms for website owners and others with downloadable content to require or encourage their audience to accept delivery of advertising using ADT is also provided.

Owners of websites and others that offer downloadable content may participate in a rewards program whereby they earn a reward (may include cash, percentage of advertisement revenue, advertising credit, air-miles or other commonly used compensation/rewards mechanisms) whenever a User downloads an object from their website using ADT. Browser and other software owners (e.g. the bidding toolbar) may also share in a similar type of rewards program if they incorporate ADT as a standard feature in their browser or other end-user software. The amount of the reward may be automatically tracked and calculated by an enhanced version of ADT. Owners may check balances and redeem rewards by logging into their accounts on specially designated websites. Alternatively, program participants may enter into separate agreements outlining terms specific for downloads on their websites or for incorporation of ADT into their software.

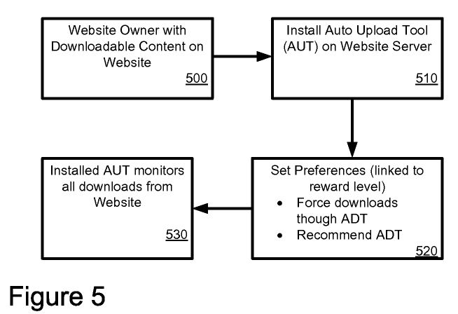

FIG. 5 shows a flowchart illustrating how website owners with downloadable content may install a second utility tool (“Auto-Upload Tool” or “AUT”) on their website servers. A website owner with downloadable content (step 500) installs AUT on its website servers (step 510) and sets its preferences to either force Users to use ADT when downloading from that owner's website (or include ADT as part of the owner's download and then require the end-user to agree to both installs) or to recommend that the User install ADT (step 520). The owner's preferences may be linked to different tiers of rewards so as to encourage the owner to promote ADT. The installed AUT then monitors all User-initiated downloads from the website owner's website (step 530).

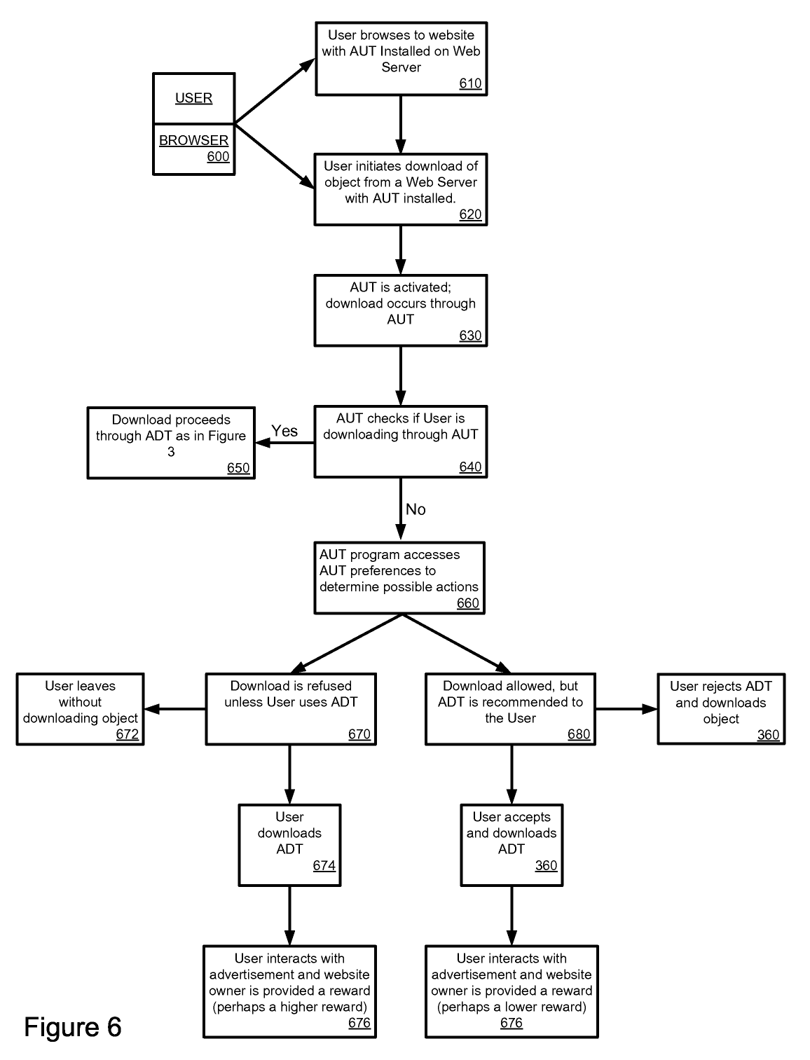

FIG. 6 shows a flowchart illustrating a typical method of incentivising website owners to promote ADT to their users. A User surfing the Internet using a browser (600) arrives at an AUT-installed website (610) and initiates a download (620). Alternatively, the User may begin the download without coming to the website (by clicking on a weblink outside the website) and arrive at step 620. From the website owner's side, the download occurs through AUT (630) which checks if the User is downloading using ADT (640). If the User is using ADT, then the download proceeds according to the flowchart depicted in FIG. 3 (650).

If the User is not using ADT, then AUT checks the website owner's preferences (660). If the owner has selected to require the User to use ADT (670), then the User is asked to download ADT (either by itself first or as a combined installation with the website owner's download that the User is seeking to obtain). The User may then either refuse and abandon the download (672) or agree, download and install ADT (674). Then if the User views, clicks on or otherwise interacts with an advertisement (depending on how the advertiser has decided to pay-pay per view, pay per click, etc.) while the User continues his or her original download, the website owner receives a reward for such interaction and for all such future interactions when any ADT-enabled User downloads an object from the website owner's website.

On the other hand, if the website owner has selected only to recommend ADT to Users (680), the User may either refuse ADT and continue his or her original download (682) or agree to download, install and use ADT (684). If the User downloads, installs and interacts with the presented advertisements on ADT, the website owner earns a reward for such interaction and for all such future interactions when any ADT-enabled User downloads an object from the website owner's website. As an additional incentivization option, website owners who require their Users to use ADT may receive a greater amount of reward for such interactions (676) whereas website owners who merely recommend ADT receive a smaller amount reward (686).

FIG. 1 illustrates a system that one may use to implement the above incentivization scheme. As indicated above, various modifications to the disclosed embodiments will be apparent to those skilled in the art, and the general principles set forth above may be applied to other embodiments and applications.

In addition, Users may be offered incentives to install and use the ADT program 145. Such incentives may include those described in detail for adopting a tracking toolbar in Provisional Patent Application 60/912, 907 (filed Apr. 19, 2007).

What is claimed is:

1. A method for delivering advertising to online users, the method comprising the steps of:
detecting a period of inactivity on a user device;
selecting an advertisement for display on the user device; and
displaying the advertisement on the user device.

2. The method of claim 1, wherein the step of selecting an advertisement for display on the user device includes computation based on at least one of the following types of data: the type of content being downloaded, the nature of the website from the content is downloaded, associated communications, keywords from within an e-mail or instant message, services provided by the download, associated software program, commonly known properties of the object being downloaded, user historical browsing profile, user search engine requests, user preferences, user purchases, user personal/demographic information and categories with associated attributes.

3. The method of claim 1, wherein the step of selecting an advertisement for display on the user device is not based on user data.

4. The method of claim 1, wherein the step of selecting an advertisement is performed randomly.

5. The method of claim 1, wherein the step of selecting an advertisement for display on the user device is based on at least one of the following types of targeted advertising methods: behavioral, demographic, search and navigational.

6. The method of claim 1, wherein the step of selecting an advertisement for display on the User Device is performed by the Local Match Engine on at least one of the following: Local Database and Central Database.

7. The method of claim 1, wherein the step of selecting an advertisement for display on the User Device is performed by the Match Engine on the Central Database and wherein the step of displaying the selected advertisement includes transferring data to the User Device.

8. The method of claim 1, wherein the step of selecting an advertisement for display on the User Device is performed by the Match Engine on the Central Database and includes transferring data from the User Device to the Central Database Server Device and wherein the step of displaying the selected advertisement includes transferring data from the Central Database Server Device to the User Device.

9. The method of claim 1, wherein the step of displaying the advertisement on the User Device is performed during a period of inactivity.

10. The method of claim 1, wherein the step of displaying the advertisement on the User Device is performed during a future period of inactivity.

11. The method of claim 1, further comprising the steps of:
transferring at least one advertisement from the Central Database Server Device to the User Device during a non-download or low bandwidth usage period; and
storing said advertisement in the User Device.

12. A system for delivering advertising to online users, the system comprising:
a User Device configured to display at least one advertisement received via a Communication Network; and
a Central Database Server Device configured to receive and transmit data related to the delivery of advertisements to at least one User Device over the Communication Network, the Central Database Server Device including:
a Central Database configured to store the data related to the advertisements and the user; and
a Match Engine configured to receive data from the User Device and the Central Database and to respond to such data by providing a suitable advertisement to be transmitted to the User Device.

13. The system of claim 12 wherein the system further comprises an Advertiser Device configured to enable Advertisers to place and monitor advertisements on the Central Database Server Device, the Advertiser Device, including an Interface configured to direct communications exchanged over the Communication Network between the Advertiser Device and the Central Database Server Device.

14. The system of claim 12 wherein the system further comprises:
a Website Server Device configured to receive and transmit data to the Central Database Server Device, the Website Server Device including:
a local database to store webpages; and
machine programmable code configured to do at least one of the following: respond to, monitor, store and report user activity in connection with a user interacting at least one of the stored webpages via the Communication Network.

15. The system of claim 12 wherein the User Device further includes:
machine programmable code configured to enable the User Device to do at least one of the following: respond to, collect, monitor and store data;
a local database, configured to store data and to receive and transmit data over the Communication network; and
a local match engine, configured to respond to data and provide an appropriate advertisement for display on the User Device.

16. A method for rewarding Website Owners for verifying the presence of actively engaged Machine Programmable Code as set forth in claim 15 (“Active Code”) and facilitating the installation thereof, the method comprising the steps of:
detecting a download event initiated by a User Device on the Website Server Device;
verifying the presence of Active Code on the User Device;
monitoring advertisements displayed on User Device; and
providing rewards to Website Owners.

17. The method of claim 16, further comprising the step of:
facilitating the installation of Active Code on the User Device if Active Code is not detected on the User Device.
